(19) United States
(12) Patent Application Publication
(10) Pub. No.: US 2025/0283635 A1
(43) Pub. Date: Sep. 11, 2025

(54) WATER HEATER SEDIMENT DRAINING SYSTEM

(71) Applicant: David Sims, Jr., Elkhart, IN (US)

(72) Inventor: David Sims, Jr., Elkhart, IN (US)

(21) Appl. No.: 18/601,305

(22) Filed: Mar. 11, 2024

(51) Int. Cl. F24H 15/14; F16K 7/16; F16K 27/02; F16K 31/06; F24H 9/16

(52) U.S. Cl. CPC F24H 15/14; F16K 7/16; F16K 27/0236; F16K 31/0655; F24H 9/16

(57) ABSTRACT

A valve for use in draining sediment from a water heater that includes a valve seat that connects an inlet and an outlet. A diaphragm is located adjacent to the valve seat and is movable between an open and closed position. The closed position locates the diaphragm in sealing contact with the valve seat and the open position locates the diaphragm at a location spaced from the valve seat to facilitate the flow of fluid between the inlet and the outlet. A spring biases the diaphragm in sealing contact with the valve seat in the closed position. An electromagnetic coil is used to move an actuator rod to position the diaphragm into the open position. A controller may be connected to the coil and may be programmed to selectively energize the electromagnetic coil and move the diaphragm.

### BACKGROUND OF THE INVENTION

Water heaters receive water from a source at a relatively low temperature and heat the water to a relatively high temperature for use in a residential or commercial building. Often water heaters are fed by a single inlet and water leaves a single outlet after being heated. The water entering the inlet usually contains impurities. The impurities are often dissolved minerals including lime. As the water is heated the lime and other minerals can precipitate out of the water and form sediment that collects near the bottom of the water heater. Over time the sediment will decrease the effectiveness of the heat source that heats the water. That heat source can be a heating element or a burner near the bottom of the tank in the case of gas fired water heaters. The heat source is forced to work much harder to provide the same temperature of water at the outlet. This can cause overheating of certain parts of the water tank of the water heater. That overheating can lead to cracks and leaks within the water tank.

Water heater manufacturers are aware of sediment in the tank being a potential problem and recommend flushing the tank periodically. As such, water heaters are supplied with a valve near the bottom to allow sediment to flow out when the valve is opened. The valve that is supplied with a water heater is usually very low quality to reduce the cost of the water heater. Often the valve is a simple gate valve that is manually operated. Although it is advisable to flush water heaters, people rarely do. Basic activity of occupying a building necessitates the use of hot water every day. Water heaters are one of the hardest working appliances in a home or business, yet are usually ignored. The only time a water heater may receive the attention it deserves is when it fails to supply hot water at an adequate level or leaks enough that it is noticed. At that time, it is too late to undo damage to the water heater and the surrounding structure that could have been prevented had periodic draining of the sediment been done. There remains an unmet need to have a more automated system that can reliably drain a water heater and still seal after the sediment is drained while requiring minimal human intervention to make that task of draining sediment happen.

### SUMMARY OF THE INVENTION

A valve with a fluid inlet in communication with a water heater and in fluid communication with a first chamber. The valve has an outlet in fluid communication with a second chamber. The valve includes a valve seat that connects the first and second chambers. A diaphragm is located adjacent to the valve seat and is movable between an open and closed position. The closed position locates the diaphragm in sealing contact with the valve seat and the open position locates the diaphragm at a location spaced from the valve seat to facilitate the flow of fluid between the inlet and the outlet. A spring biases the diaphragm in sealing contact with the valve seat in the closed position. The diaphragm is connected to an actuator rod. The actuator rod is surrounded by an electromagnetic coil. The coil has an energized state in which electricity passes through the coil. The coil also has an unenergized state where no electricity passes through the coil. The energized state of the coil moves the actuator rod to position the diaphragm into the open position. A controller may be connected to the coil and may be programmed to selectively energize the electromagnetic coil and move the diaphragm.

### BRIEF DESCRIPTION OF THE DRAWINGS

FIG. 1 is an isometric view of a water heater showing a partial sectional view of the tank;

FIG. 2 is a sectional view of the water heater shown in FIG. 1 with the valve of the present invention attached;

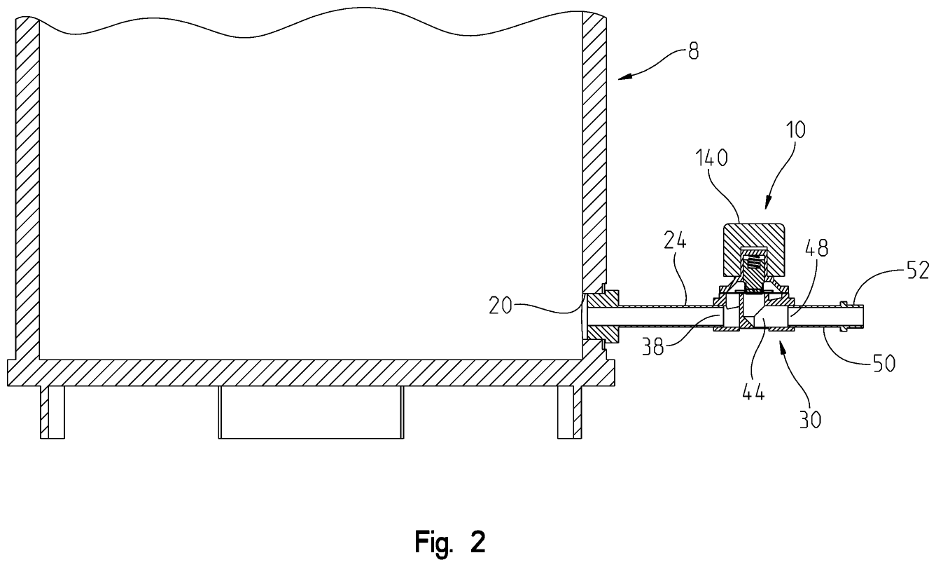

FIG. 3 is an isometric view of the valve shown in FIG. 2;

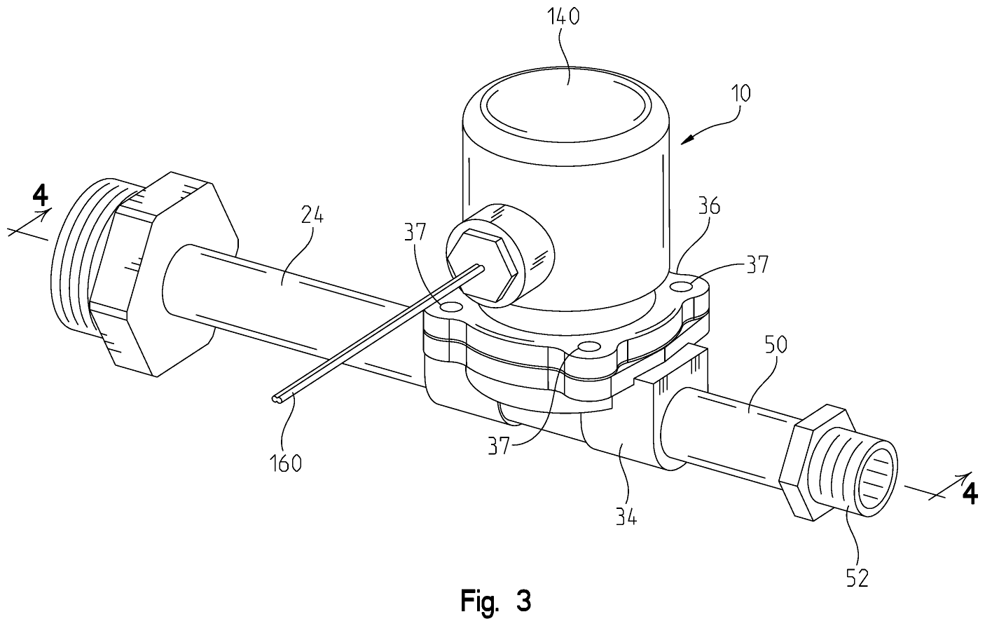

FIG. 4 is a sectional view of the valve taken about line 4-4 in FIG. 3 showing the valve with the diaphragm in the closed position;

FIG. 5 is the view shown in FIG. 4 with the diaphragm in the open position; and

FIG. 6 is a magnified view showing area 6 in FIG. 5.

### DETAILED DESCRIPTION OF INVENTION

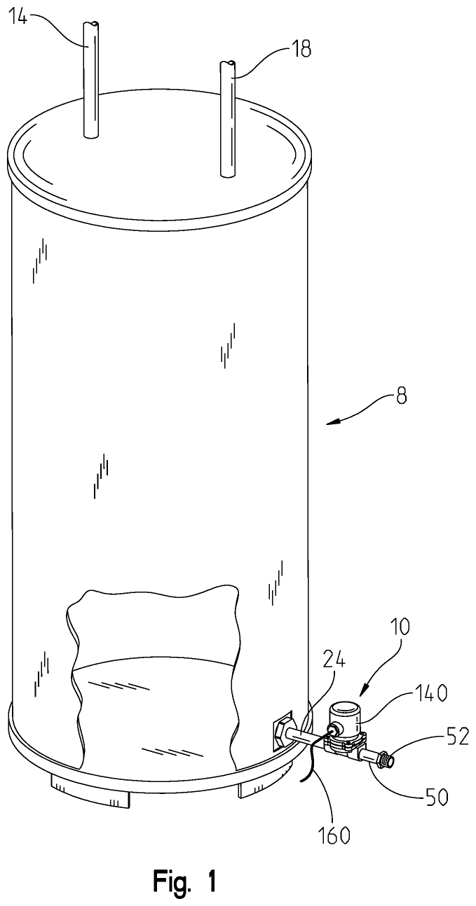

FIG. 1 shows a water heater 8 with the valve 10 of the present invention connected to it. The water heater 8 has an inlet 14 that supplies water at a relatively cool temperature. That temperature is often as cold as the water comes from an underground source. The water has an outlet 18 that is also on the top, and supplies the heated water to the plumbing system of a building into which the water heater 8 is installed. The water heater 8 also has a sediment drain aperture 20. The sediment drain aperture 20 is located near the bottom of the water heater 8 and to facilitates the clearing of sediment. The sediment drain aperture 20 is threaded to receive a valve that is originally supplied with the water heater 8 (the original valve is not shown). The original valve is a low-quality valve that is usually as inexpensive as possible so that the manufacturer of the water heater 8 can reduce their costs to produce the water heater 8.

The valve 10 of the present invention has a connector pipe 24 that is threaded directly into the drain aperture 20. The connector pipe 24 spaces the valve body 30 away from the water heater. The valve body 30 has a first housing section 34 and a second housing section 36. The first housing section 34 has an inlet 38 leading to a first chamber 40 that is in communication with the connector pipe 24. The connector pipe 24 is threaded into the inlet 38 and therefore the inlet 38 and first chamber 40 are in fluid communication with the sediment drain aperture 20. The first housing section 34 has a second chamber 44 that is connected to an outlet 48. The outlet 48 is threaded to receive an outlet pipe 50 that has a threaded end 52 for receiving a garden hose or other type of hose that may be used to direct water to a desired location such as a drain or sump. The first chamber 40 and the second chamber 44 are located on either side of an annular sidewall 51 that terminates in a valve seat 53. The sidewall 51 surrounds passage 56 that connects the first chamber 40 and the second chamber 44. The passage 56 provides fluid communication through the entire first housing section 34 from the inlet 38 to the outlet 48. The valve seat 53 may be a rounded surface surrounding passage 56 although it is shown as more of a blunt and flat surface in the FIGS. for clarity. The entire first housing section 34 has a first mating surface 60 that is a flat surface surrounding the sidewall 51 with the first mating surface 60 being spaced from the sidewall 51 to facilitate the flow of fluid from the inlet 38 through passage 56.

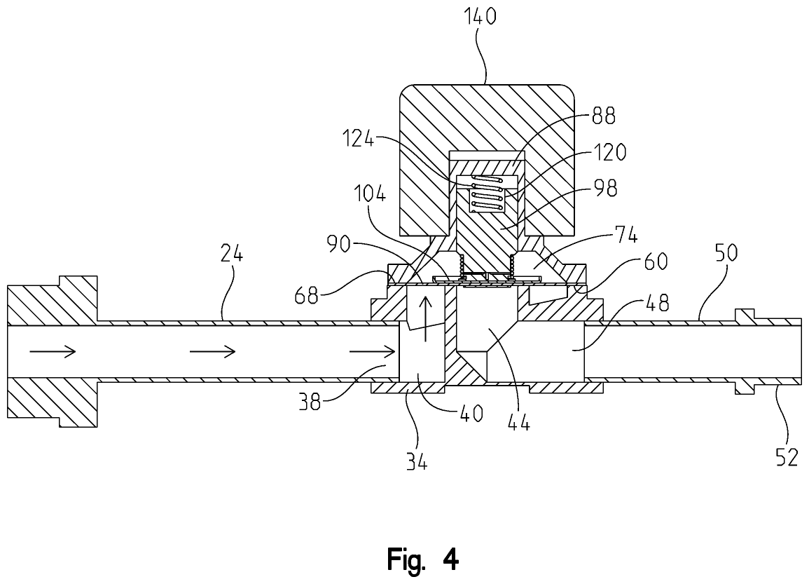

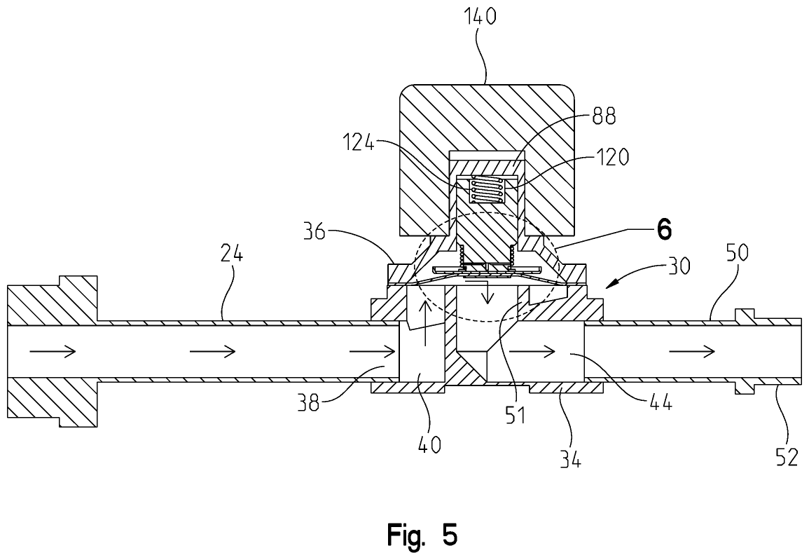

The second housing section 36 is designed to be mated with the first housing section 34. The connection between the first housing section 34 and the second housing section 36 is typically made with screws driven through holes 37 that hold the two parts together. The second housing section 36 has a second mating surface 68 that is adapted for being held adjacently next to the first mating surface 60 of the first section. The second mating surface 68 surrounds an upper chamber 74 that is spaced from said second mating surface 68 in an opposite direction of the first housing section 36. The upper chamber 74 forms a bowl-shaped depression in the second housing section 36 that is directly connected to an actuator rod guide tube 80. The actuator guide tube 80 has a cylindrical sidewall 84 and an end wall 88 that defines the end of the guide tube 80. The second housing section 36 and first housing section 34 are clamped together with screws and form the configuration shown in FIGS. 4 and 5.

The first and second housing sections 34, 36 clamp together across their respective mating surfaces 60, 68 to hold a diaphragm 90 between them. The diaphragm 90 effectively separates the first and second housing sections 34, 36 and prevents any fluid from entering into the upper chamber 74. The diaphragm 90 is connected to an actuator rod 98. The actuator rod 98 is slidable within the actuator rod guide tube 80. The diaphragm 90 has a reinforcing washer 104 that is aligned with the central axis 108 of the actuator rod 98. The reinforcing washer 104 has a larger diameter than the diameter of the sidewall 50 that forms the valve seat 53. The outer diameter of the reinforcing washer 104 has a ridge 110 that stiffens the reinforcing washer 104 so that it remains flat. The reinforcing washer 104 is on the same side of the diaphragm 90 as the second housing section 36 and this locates the reinforcing washer 104 opposite the valve seat 53. The reinforcing washer 104 includes an upstanding nub 116 that is for contacting the lower end of the actuator rod 98. The upper end of the actuator rod 98 has a pocket 120 that receives a spring 124 that exerts a pushing force between the actuator rod 98 and end wall 88. This biases the actuator rod 98 toward the valve seat 53. Spring 124 pushes the actuator rod 98 into the reinforcing washer 104 so that the reinforcing washer 104 forces the diaphragm 90 against the valve seat 53. This spring 124 seals passage 56 from the flow of fluid. The lower end of the actuator rod 98 opposite end wall 88 has a second spring 130 that is affixed to the lower end of the actuator rod 98 and to the reinforcing washer 104. The second spring 130 fits into a notch 134 that is located on the reinforcing washer 104 that affixes the second spring 130 to the reinforcing washer 104. The second spring 130 pulls the reinforcing washer 104 against the upstanding nub 116. The upstanding nub 116 has a relatively small area where it contacts the actuator rod 98. The small contact area of the upstanding nub 116 and the actuator rod 98 allows the reinforcing washer 104 to be slightly off from perpendicular to the central axis 108 of the actuator rod 98. That ability to allow for slight variation from perpendicular allows the reinforcing washer 104 to be pushed against the diaphragm 90 and valve seat 53 in the event the vale seat 53 is not perpendicular to the central axis 108. The reinforcing washer 104 may be skewed by small particulate between the valve seat 53 and the diaphragm 90. Having a flexible connection that the second spring 130 provides allows the diaphragm 90, which is an elastomeric material, to be pushed tight against the valve seat 53 in the event some small particulate comes between the diaphragm 90 and the valve seat 53. Thus, the sealing function of the diaphragm 90 being biased by spring 124 will not be degraded by small particulate that may be present within the valve 10.

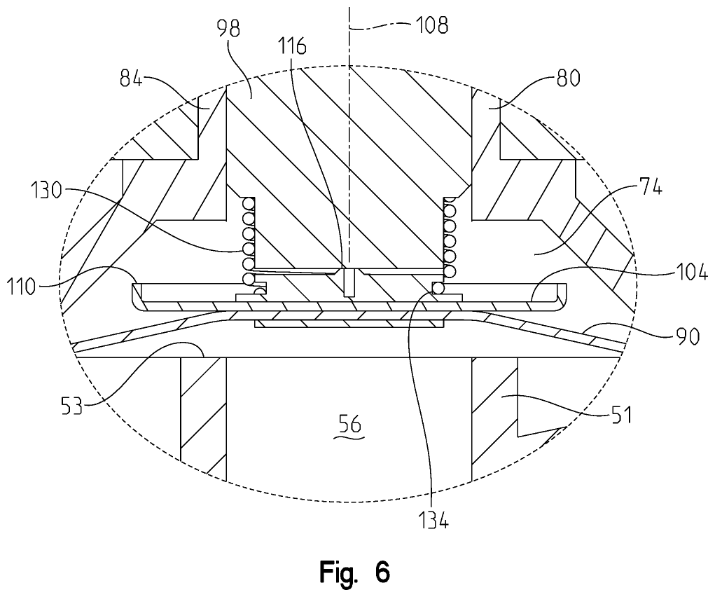

The actuator rod guide tube 80 and the actuator rod 98 are surrounded by an electromagnetic coil 140. The electromagnetic coil 140 sits on top of the second housing section 36. The electromagnetic coil 140 has an energized state when electricity passes through the coil 140 and an unenergized state when no electricity is passed through the coil 140. The energized state of the coil 140 generates a magnetic force that pulls the actuator rod 98 away from the valve seat 53 and toward the end wall 88 against the bias of spring 124. This corresponds to the diaphragm being in its open position, as shown in FIGS. 5 and 6. The open position of the diaphragm 90 spaces the diaphragm 90 and reinforcing washer 104 from the valve seat 53. The open position of the diaphragm 90 allows the flow of fluid from the inlet 38 to the outlet 48. When the coil 140 is in its unenergized state, the spring 124 biases the diaphragm 90 into its closed position as shown in FIG. 4. In the closed position of the diaphragm 90, fluid flow from the inlet 38 to the outlet 48 is blocked.

The coil 140 is connected to a controller (not shown) that selectively sends electricity to wires 160 leading into the coil 140. The controller may supply electricity to the coil 140 at selected intervals to facilitate periodic draining of sediment within the water heater 8 by opening the valve 10. When electricity is supplied to the coil 140 water and sediment will be passed through passage 56 and out of the water heater as the diaphragm 90 is moved into its open position. Once draining of sediment is accomplished by having the valve 10 open for an appropriate time, electricity is shut off to the coil 140 and the valve 10 will be biased into the closed position with spring 124. This configuration acts as a fail safe so that in the absence of power because the valve 10 is closed and the water heater 8 will be closed. Draining can only occur with the supply of power moving the diaphragm 90 into its open position. It is also contemplated that a user of the valve 10 may purposely actuate the valve 10 by switching power on to the coil 140 to open the valve 10.

The details above are not intended to limit the scope of coverage which may be modified within the scope of the following claims.

What is claimed is:

1. A draining system in combination with a water heater having a single water inlet for receiving water into a tank and a single water outlet for discharging heated water from said tank, a sediment drain aperture being located below said water inlet and said water outlet, said draining system comprising:
a connector pipe for connecting to said sediment drain aperture;
a valve having an inlet in fluid communication with said connector pipe, said inlet being in fluid communication with a first chamber, said valve including an outlet in fluid communication with a second chamber, said valve including a valve seat connecting said first and second chambers, a diaphragm being located adjacent to said valve seat and being movable between an open and closed position, said closed position locating said diaphragm in sealing contact with said valve seat and said open position locating said diaphragm at a location spaced from said valve seat to facilitate the flow of fluid between said inlet and said outlet, a spring biasing said diaphragm into said closed position, said diaphragm being connected to an actuator rod, said actuator rod being surrounded by an electromagnetic coil, said coil having an energized state wherein electricity passes through said coil and an unenergized state where no electricity passes through said coil, said energized state of said coil moving said actuator rod to position said diaphragm into said open position;
a controller being connected to said coil, said controller being programmable to selectively energize said electromagnetic coil to move said diaphragm.

2. The draining system of claim 1, wherein said valve includes a first housing section and a second housing section, said first housing section including said inlet, said outlet, and said valve seat, and a first mating surface, said second housing section including an upper chamber, a second mating surface, and an actuator rod guide tube having a sidewall and an end wall, said spring located between said end wall of said actuator rod guide tube and said actuator rod, said diaphragm being held between said first and second mating surfaces.

3. The draining system of claim 2, wherein said diaphragm is connected to a reinforcing washer located opposite to said valve seat having a diameter, said reinforcing washer having a larger diameter than said diameter of said valve seat.

4. The draining system of claim 3, wherein said reinforcing washer includes an upstanding nub for contacting said actuating rod.

5. The draining system of claim 4, wherein said actuator rod includes a second spring being connected to said reinforcing washer and to said actuating rod, said spring exerting a force upon said reinforcing washer to draw it toward said actuating rod.

6. A draining system comprising:
a valve having an inlet in fluid communication with a water heater, said inlet being in fluid communication with a first chamber, said valve including an outlet in fluid communication with a second chamber, said valve including a valve seat connecting said first and second chambers, a diaphragm being located adjacent to said valve seat and being movable between an open and closed position, said closed position locating said diaphragm in sealing contact with said valve seat and said open position locating said diaphragm at a location spaced from said valve seat to facilitate the flow of fluid between said inlet and said outlet, a spring biasing said diaphragm into said closed position, said diaphragm being connected to an actuator rod, said actuator rod being surrounded by an electromagnetic coil, said coil having an energized state wherein electricity passes through said coil and an unenergized state where no electricity passes through said coil, said energized state of said coil moving said actuator rod to position said diaphragm into said open position; and
a controller being connected to said coil, said controller being programmable to selectively energize said electromagnetic coil to move said diaphragm.

7. The draining system of claim 6, wherein said valve includes a first housing section and a second housing section, said first housing section including said inlet, said outlet, and said valve seat, and a first mating surface, said second housing section including an upper chamber, a second mating surface, and an actuator rod guide tube having a sidewall and an end wall, said spring located between said end wall of said actuator rod guide tube and said actuator rod, said diaphragm being held between said first and second mating surfaces.

8. The draining system of claim 7, wherein said diaphragm is connected to a reinforcing washer located opposite to said valve seat having a diameter, said reinforcing washer having a larger diameter than said diameter of said valve seat.

9. The draining system of claim 8, wherein said reinforcing washer includes an upstanding nub for contacting said actuating rod.

10. The draining system of claim 9, wherein said actuator rod includes a second spring being connected to said reinforcing washer and to said actuating rod, said spring exerting a force upon said reinforcing washer to draw it toward said actuating rod.

11. A draining system comprising:
a valve having an inlet in fluid communication with a water heater, said inlet being in fluid communication with a first chamber, said valve including an outlet in fluid communication with a second chamber, said valve including a valve seat connecting said first and second chambers, a diaphragm being located adjacent to said valve seat and being movable between an open and closed position, said closed position locating said diaphragm in sealing contact with said valve seat and said open position locating said diaphragm at a location spaced from said valve seat to facilitate the flow of fluid between said inlet and said outlet, a spring biasing said diaphragm into said closed position, said diaphragm being connected to an actuator rod, said actuator rod being surrounded by an electromagnetic coil, said coil having an energized state wherein electricity passes through said coil and an unenergized state where no electricity passes through said coil, said energized state of said coil moving said actuator rod to position said diaphragm into said open position.

12. The draining system of claim 11, wherein said valve includes a first housing section and a second housing section, said first housing section including said inlet, said outlet, and said valve seat, and a first mating surface, said second housing section including an upper chamber, a second mating surface, and an actuator rod guide tube having a sidewall and an end wall, said spring located between said end wall of said actuator rod guide tube and said actuator rod, said diaphragm being held between said first and second mating surfaces.

13. The draining system of claim 12, wherein said diaphragm is connected to a reinforcing washer located opposite to said valve seat having a diameter, said reinforcing washer having a larger diameter than said diameter of said valve seat.

14. The draining system of claim 13, wherein said reinforcing washer includes an upstanding nub for contacting said actuating rod.

15. The draining system of claim 14, wherein said actuator rod includes a second spring being connected to said reinforcing washer and to said actuating rod, said spring exerting a force upon said reinforcing washer to draw it toward said actuating rod.
